(19) United States
(12) Patent Application Publication
(10) Pub. No.: US 2023/0154299 A1
(43) Pub. Date: May 18, 2023

(54) Security Camera System Set Up System And Method Using A Bluetooth Connection

(71) Applicant: NIGHT OWL SP, LLC, Naples, FL (US)

(72) Inventors: Craig Greenberg, Delray, FL (US); BENOIT CHIROUTER, Taipei (TW); DANIEL KUANG, Dongguan City (CN)

(21) Appl. No.: 17/984,949

(22) Filed: Nov. 10, 2022

Related U.S. Application Data
(60) Provisional application No. 63/279,039, filed on Nov. 12, 2021.

(51) Int. Cl. G08B 13/196; H04W 12/55; H04W 4/80

(52) U.S. Cl. CPC G08B 13/1968; G08B 13/1966; G08B 13/19669; G08B 13/1961; H04W 12/55; H04W 4/80

(57) ABSTRACT

System and method of configuring a recorder using a mobile device that includes powering on a recorder, wherein the recorder is configured to receive and store surveillance data from surveillance cameras, pairing the recorder to a mobile device via a Bluetooth connection, and using the mobile device and the Bluetooth connection to configure one or more settings of the recorder.

### RELATED APPLICATIONS

This application claims the benefit of U.S. Provisional Application No. 63/279,039, filed Nov. 12, 2021, and which is incorporated herein by reference.

### FIELD OF THE INVENTION

The present invention relates to security camera systems, and more particularly to camera systems that use a recorder to store surveillance data.

### BACKGROUND OF THE INVENTION

Conventional security camera systems include one or more cameras for capturing surveillance data (e.g., video alone or together with audio captured from surveilled area(s)), and a recorder (e.g., a digital video recorder also referred to as a DVR, a network video recorder also referred to as an NVR, etc.) for storing the surveillance data captured by the cameras. The cameras can be wired meaning that the surveillance data is conveyed from the cameras to the recorder via wires extending between the recorder and cameras (i.e., a wired connection), or the cameras can be wireless meaning the surveillance data is conveyed by wireless transmission such as over a Wi-Fi router or network (a wireless connection) from the cameras to the recorder. The surveillance data can be visually displayed on a monitor connected to the recorder. If the recorder is connected to a network such as Wi-Fi, cellular, and/or the Internet, then the surveillance data can be streamed from the recorder, over the network, and to a separate mobile device located nearby or located remotely.

When initially installing security camera systems, conventional systems often require the user to connect a monitor, keyboard and mouse to the recorder to set up the recorder. Initial set up can include setting up a user password and/or PIN, searching for and identifying connected cameras, setting up camera detection and recording options, setting up a network connection, setting up remote access, etc. Mobile devices using mobile applications are available, whereby a CRT code displayed on the monitor connected to the recorder or provided on the recorder case can be captured by the mobile device's camera and used by the mobile application for authentication and to create a secure link to the recorder if it is network connected to the recorder. Once a secured connection is established, the mobile application can display the surveillance data captured by the cameras for use with, for example, aiming the cameras once they are mounted in their final locations.

For many users, it can be inconvenient to connect a monitor, keyboard and mouse to the recorder for initial set up, especially for users that plan to use the recorder all by itself without any such additional equipment which may not be available or convenient. Typing in information using an embedded keyboard (i.e., a keyboard that is displayed on the monitor where the user points and clicks on the soft keys using the mouse) can be difficult to use as well. Further, the recorder may also lack a network connection at the time of initial set up, and possibly even after initial set up. In such cases, initial set up can be challenging.

### BRIEF SUMMARY OF THE INVENTION

The aforementioned problems and needs are addressed by method of configuring a recorder using a mobile device, comprising powering on a recorder, wherein the recorder is configured to receive and store surveillance data, pairing the recorder to a mobile device via a Bluetooth connection, and using the mobile device and the Bluetooth connection to configure one or more settings of the recorder.

A security camera system comprises one or more cameras configured to generate surveillance data, and a recorder. The recorder includes a processor and a storage device configured to receive and store the surveillance data, and a Bluetooth transceiver configured to pair the recorder to a mobile device via a Bluetooth connection, wherein the processor and the storage device are configured to set and store one or more settings of the recorder in response to information received over the Bluetooth connection.

A security camera system, comprises a mobile device that includes a first Bluetooth transceiver, one or more cameras configured to generate surveillance data, and a recorder. The recorder includes a processor and a storage device configured to receive and store the surveillance data, and a second Bluetooth transceiver configured to communicate with the first Bluetooth transceiver via a Bluetooth connection, wherein the processor and the storage device are configured to set and store one or more settings of the recorder in response to information received from the mobile device over the Bluetooth connection.

Other objects and features of the present disclosure will become apparent by a review of the specification, claims and appended figures.

### BRIEF DESCRIPTION OF THE DRAWINGS

FIG. 1 is a schematic drawing showing a recorder connected to cameras with wired connections.

FIG. 2 is a schematic drawing showing a recorder connected to cameras with wireless connections.

FIG. 3 is a flow diagram showing the process of initially setting up the recorder via a Bluetooth connection.

FIG. 4 is a flow diagram showing the process of pairing the recorder with a mobile device and its app via a Bluetooth connection.

FIG. 5 is a flow diagram showing the process of configuring the settings of the recorder using the mobile device and its app via a Bluetooth connection.

FIGS. 6A-6L are screen shots from the app running on the mobile device illustrating the process of configuring the settings of the recorder using the mobile device and its app via a Bluetooth connection.

FIGS. 7A-7B are screen shots from the app running on the mobile device illustrating the process of configuring the settings of the recorder using the mobile device and its app via a Bluetooth connection and a network connection.

### DETAILED DESCRIPTION OF THE INVENTION

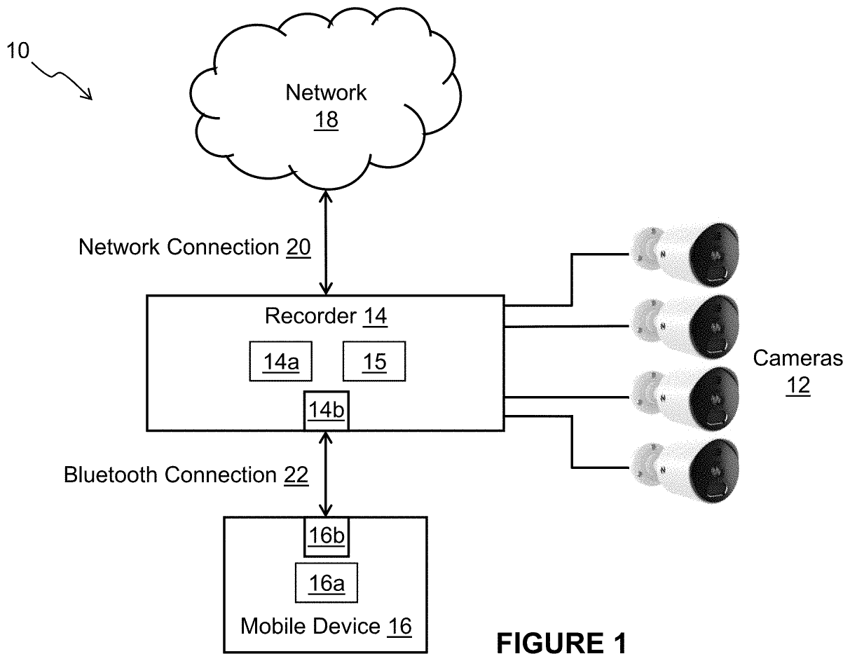

A security camera system and method is disclosed that connects a recorder to a mobile device over Bluetooth for performing initial set-up of the recorder. The main components of the security camera system 10 are shown in FIG. 1, and includes one or more cameras 12 (for capturing surveillance data in the form of video alone or additionally with audio from the surveilled areas), a recorder 14 (that receives the surveillance data from the cameras and records (stores) it internally on a storage device 15 such as a hard disk drive or solid state drive), and a mobile device 16 (such as a smart phone or tablet, etc.) that has Bluetooth connection functionality on which a mobile application (app) is installed. However, it should be understood that the present example could also be implemented using a mobile device 16 either running a local application, or running a web based application, configured for communicating with the recorder using a Bluetooth connection.

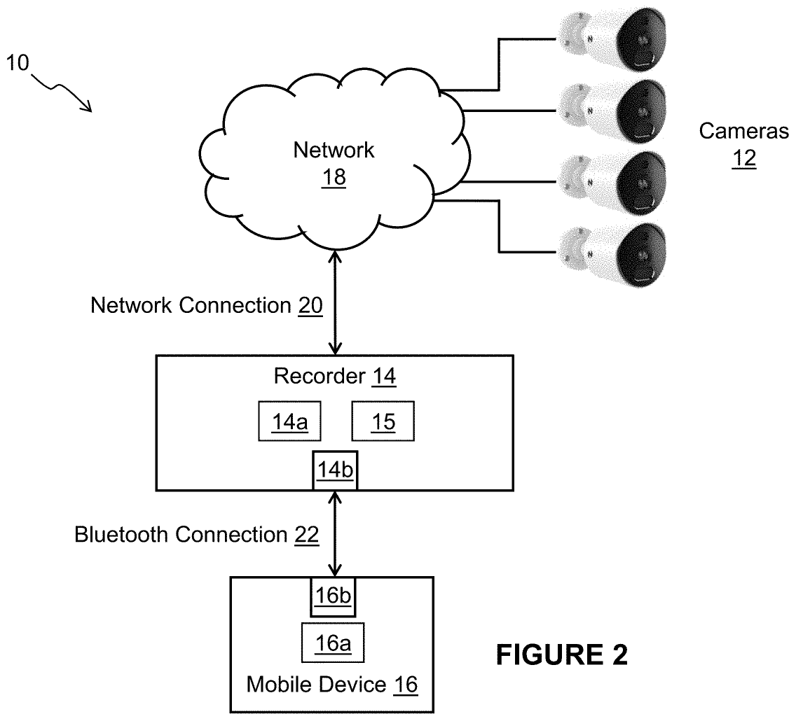

The cameras 12 can be connected to the recorder 14 by wires, as shown in FIG. 1. Alternately, the cameras 12 can be connected to the recorder 14 by a network 18 that can include one or more of the following: Wi-Fi, cellular, the Internet, etc., as shown in FIG. 2. The cameras 12 capture surveillance data and transmit it to the recorder 14, whereby the recorder 14 records the surveillance data on the storage device 15 for later play back. The recorder includes a processor 14a for controlling the operation of the recorder 14. The recorder 14 can display the recorded surveillance data on a connected monitor if one is available, or on a mobile device over the network 18. The network connection 20 from the recorder 14 to the network 18 can be wired (e.g., ethernet wire connected between the recorder 14 and a router for network 18) or can be wireless (e.g., a wireless Wi-Fi connection to the router for network 18). The network 18 can include a wired router, a wireless router (e.g. Wi-Fi), and can include multiple network components (e.g., a Wi-Fi router that itself is connected to the Internet).

Conventional mobile devices (e.g., cell phones, tablets, laptops, etc.) typically include as many as four communication modes: (1) cellular communications (e.g. to nearby cell towers), (2) Wi-Fi communications (e.g., to a nearby wireless Wi-Fi router, which itself can be connected to the Internet), (3) Bluetooth communications (a standardized wireless technology that uses a radio frequency to share data point to point over a short distance), and (4) cable communications (with a cable plugged into the mobile device).

The present example is directed to the use of a Bluetooth connection 22 between the mobile device 16 and the recorder 14 for initial set up of the recorder 14, with only some or no reliance on any other network connection for communicating with the mobile device 16. The non-limiting example of the mobile device 16 described below is a smartphone or tablet having a processor 16a for controlling the operation of the mobile device 16. The Bluetooth connection 22 is established between a Bluetooth transceiver 14b in recorder 14 and a Bluetooth transceiver 16b in the mobile device 16.

Bluetooth is a short-range wireless technology standard that is typically used for exchanging data between two devices over short distances using UHF radio waves in the ISM bands, from 2.402 GHz to 2.48 GHz, and building personal area networks (PANs). It is mainly used as an alternative to wire connections, to exchange files and digital information between two proximately located devices (i.e., a point to point sharing of information). Examples of a known Bluetooth connection include connecting a cell phone with a nearby device such as a wireless head phone, an automobile entertainment system, or a smart watch. In the most widely used mode, transmission power is limited to 2.5 milliwatts, giving it a very short range of up to approximately 10 meters (i.e., approximately 30 feet). The short range feature of Bluetooth is an important security feature for the present example, as it requires the mobile device 16 to be proximate to the recorder 14, which not only ensures the user of the mobile device 16 is authorized to set up the recorder 14, but can also be used to automatically unlock the recorder 14 after initial set up when the mobile device 16 becomes proximate to the recorder and the Bluetooth connection 22 is established.

Bluetooth is managed by the Bluetooth Special Interest Group (SIG), which has more than 35,000 member companies in the areas of telecommunication, computing, networking, and consumer electronics. The Bluetooth SIG oversees development of the specification, manages the qualification program, and protects the trademarks. A manufacturer should meet at least the essential requirements of Bluetooth SIG standards to market it as a Bluetooth device. Bluetooth is different from Wi-Fi, which is the generic name for products using the IEEE 802.11 standard. Wi-Fi is intended as a replacement for high-speed cabling for general local area network access in work areas, public areas, or the home. This category of applications is sometimes called wireless local area networks (WLAN). Bluetooth on the other hand is intended for portable equipment and related applications. Bluetooth is a replacement for cabling in various mobile applications and settings and also works for fixed location applications such as smart energy functionality in the home (e.g., thermostats, etc.). Wi-Fi and Bluetooth are to some extent complementary in their applications and usage. Wi-Fi is access point-centered, with an asymmetrical client-server connection with all traffic from multiple client devices routed through the access point. In contrast, Bluetooth provides a symmetrical wireless connection between only two Bluetooth devices. When Bluetooth enabled devices are proximate to each other, they automatically detect each other. Establishing an initial Bluetooth connection is commonly referred to as “pairing” because the Bluetooth connection is initially and securely made between the two “paired” devices. When devices are paired, they share information such as addresses, names, profiles, pairing key, etc. that are stored in memory, and which allows the devices to automatically connect to each other via Bluetooth in the future whenever they are proximate to each other. Pairing usually requires an authentication process where a user validates the connection between the devices. Bluetooth serves well in simple applications where the two devices need to connect with a minimal configuration (as simple as pressing a softkey or button to initiate pairing). Bluetooth connectively is a standard communication option for present day mobile devices, along with Wi-Fi, and in the case of cell phones, cellular connections.

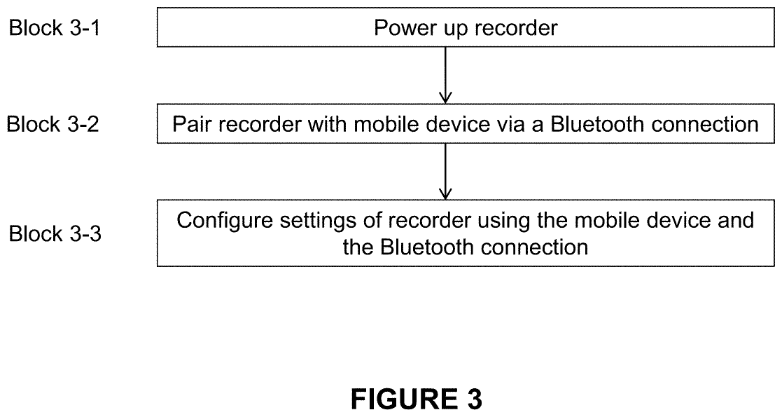

FIG. 3 illustrates the use of a Bluetooth connection with a mobile device 16 to initially set up the recorder 14. The mobile device 16 for this example is running a software application (commonly referred to as an “app”) that is configured to communicate with the recorder 14 in a secure manner. The app on the mobile device 16 uses the Bluetooth functionality to scan for available recorders that can be added to the app. When the recorder is powered up at Block 3-1, it activates its Bluetooth functionality thereby becoming visible to the mobile device 16 and its app as a possible Bluetooth connection and possible recorder device for pairing. At Block 3-2, the recorder is paired with the mobile device (and its app) via a Bluetooth connection. At Block 3-3, the settings of the recorder are configured (i.e., set and stored in the recorder in storage device 15) using the mobile device and the Bluetooth connection. More specifically, settings of the recorder are configured by the app and the user's input prompted by the app running on the mobile device, which are transmitted over the Bluetooth connection to the recorder, whereupon they are set and stored in the recorder. More simply, the settings of the recorder are set and stored in the recorder in response to information received via (i.e., over) the Bluetooth connection (from the mobile device). After the settings are configured, the recorder is operational and can record surveillance data from connected cameras according the configured settings. The configuration of the settings of the recorder can be performed without any other wired or wireless connections to the recorder including other input/output devices (e.g., a monitor, keyboard or mouse).

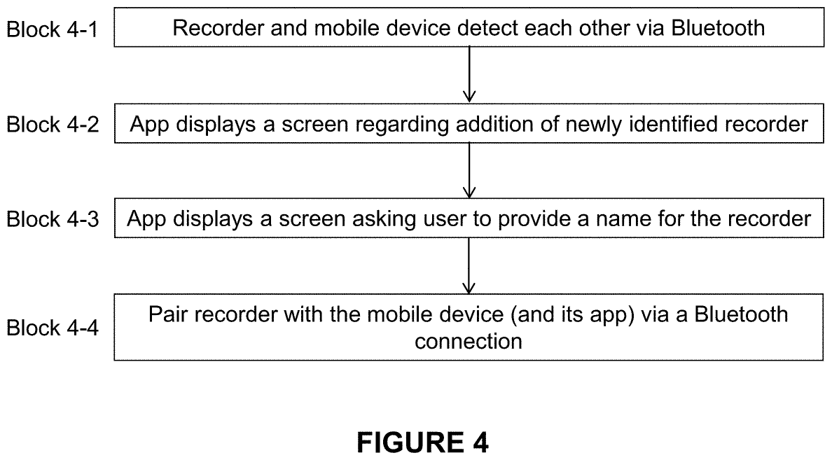

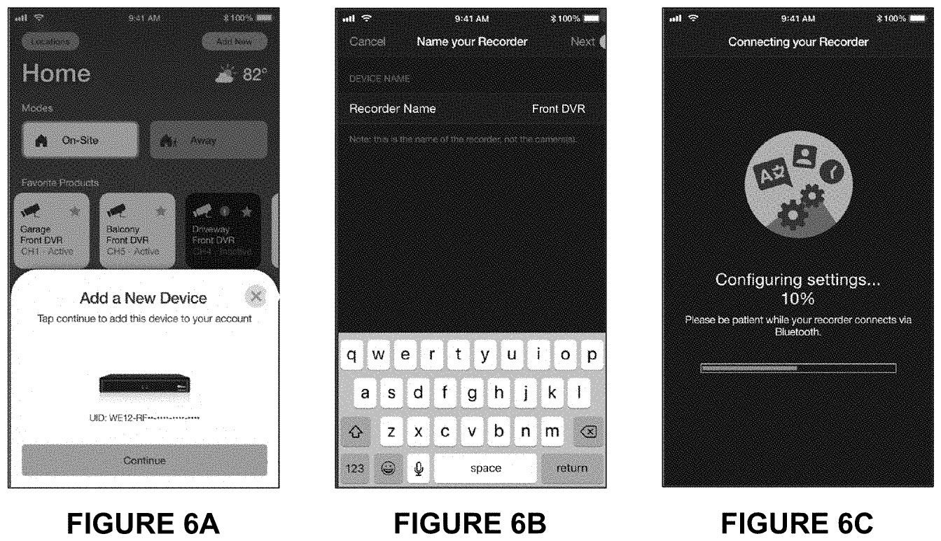

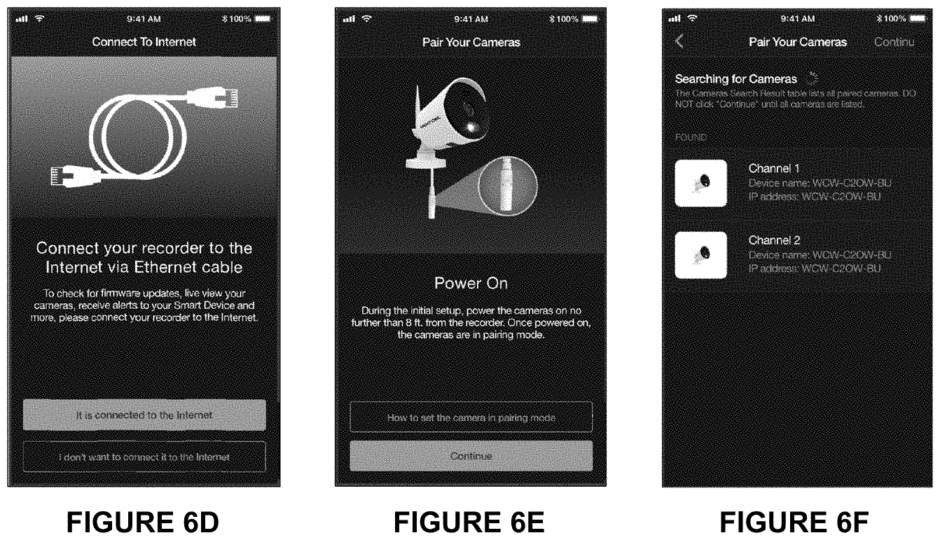

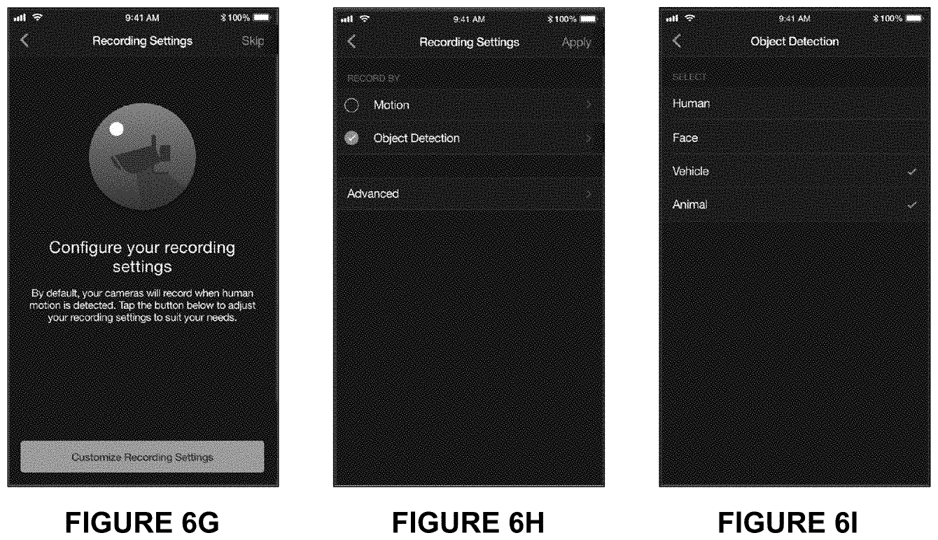

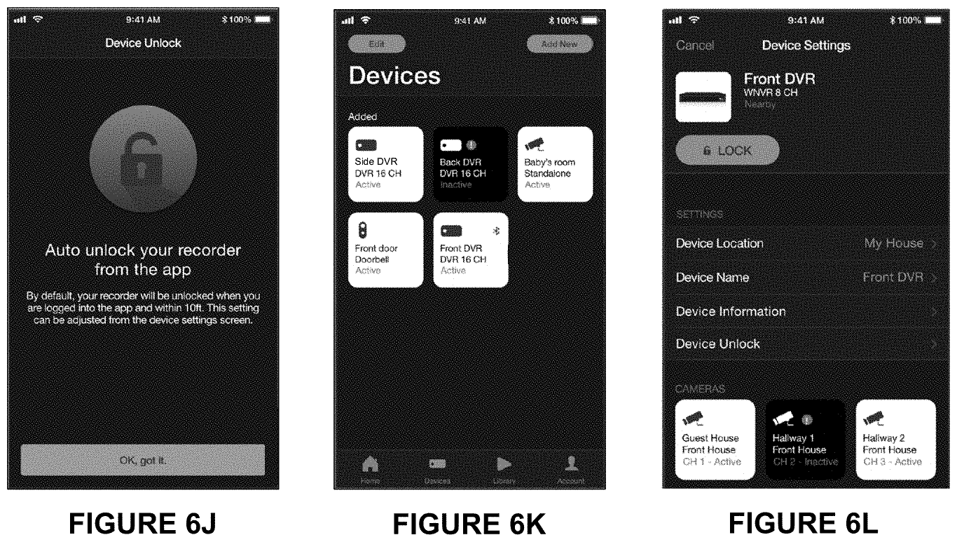

FIG. 4 illustrates in more detail the process of pairing of the recorder 14 with the mobile device 16 and its app over the Bluetooth connection after the recorder is powered up. At Block 4-1, the recorder 14 and the mobile device 16 detect each other via Bluetooth. At Block 4-2, the app displays a screen on the display of the mobile device 16 identifying to the user the newly identified recorder device. See FIG. 6A. If the user selects the continue button on this screen, the app displays a screen with a prompt for the user to enter a name for the recorder 16 (Block 4-3). See FIG. 6B. Once the name is entered by the user, then at Block 4-4, the recorder is paired to the mobile device (and its app) via a Bluetooth connection. See FIG. 6C. Specifically, the app is configured to instruct the mobile device's Bluetooth functionality to pair the recorder and the mobile device, at the same time the recorder is paired with the app. In an alternate configuration, the user can separately pair the recorder and the mobile device using the mobile device's Bluetooth functionality, and then the app can pair itself to the recorder. In either case, after the pairing, the recorder 14 can exchange information with the mobile device 16 and its app over the Bluetooth connection.

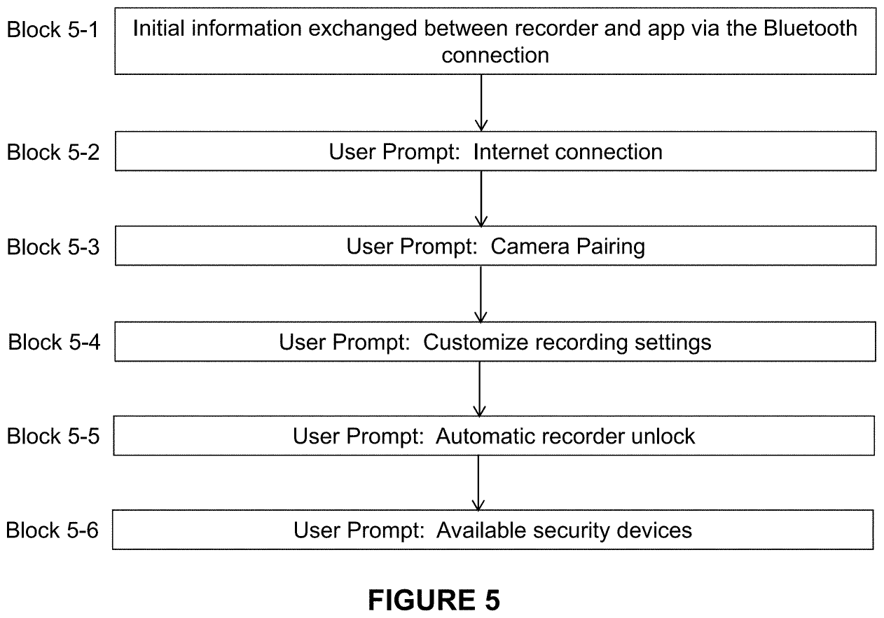

FIG. 5 illustrates in more detail the process of configuring the settings of the recorder using the mobile device and its app via the Bluetooth connection. After the pairing of the recorder to the mobile device and its app, initial information is exchanged (model/serial numbers and other information for identifying the recorder and the app to each other) at Block 5-1. The app then provides the user a series of prompts on the screen of the mobile device 16 for further configuring the settings of the recorder 14. For example, at Block 5-2, a prompt can ask the user if the recorder is connected to the Internet, or if the user does not want to connect it to the Internet. See FIG. 6D. If the user selects the option that they do not want to connect the recorder to the Internet, then configuration continues without any functionality provided by an Internet connection. At Block 5-3, another prompt may instruct the user on how to pair the cameras to the recorder. See FIG. 6E. For wired cameras, pairing may involve connecting the wires from the cameras to the recorder. For wireless cameras, pairing may involve activating a sync/reset button on the cameras. Then, the recorder 16 will search for cameras 12 to be paired to the recorder 14. If the recorder 14 is successful in finding cameras 12, the cameras are paired to the recorder (i.e., the recorder settings are set recognize and receive surveillance data from the cameras) and the paired cameras are displayed on the mobile device screen so that the user can confirm successful camera pairing with the recorder. See FIG. 6F. At Block 5-4, another prompt may provide the user the ability to customize recording settings. See FIG. 6G. For example, the user can select what will trigger storage (i.e., recording) of the surveillance data for each of the cameras. Setting options here can include the detection of any motion and/or the detection of certain object(s). See FIG. 6H. For example, the user can select setting options for objects that when detected can trigger recording, such as human, face, vehicle, and/or animal that the recorder will use to trigger recording. See FIG. 6I. At Block 5-5, another prompt informs the user that the recorder will be unlocked automatically when the user is logged into the app and located proximate to (e.g., within approximately 30 feet of) the recorder. See FIG. 6J. Finally, at Block 5-6, a prompt screen can appear showing all the security devices available to the user, including the recorder that was just configured. See FIG. 6K. Selecting the recorder that was just configured on this screen can result in another screen showing options that the user can take with the now set-up recorder. See FIG. 6L.

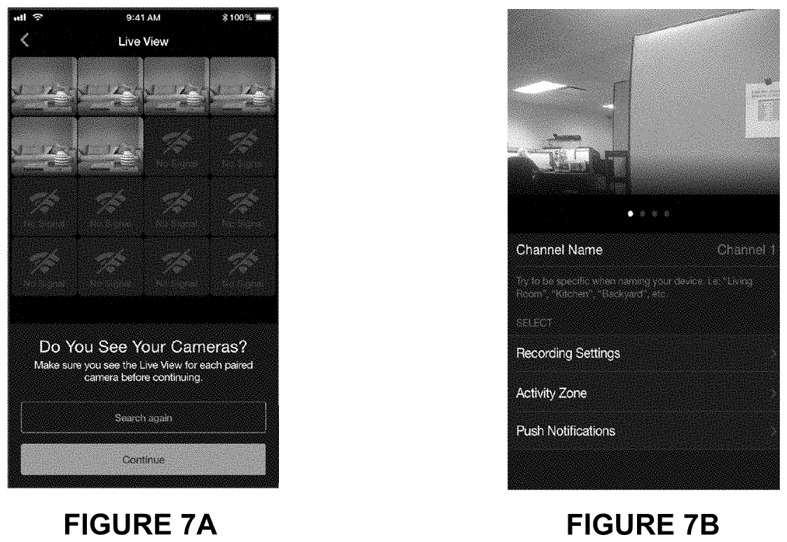

The user prompts described above for recorder configuration via the Bluetooth connection are examples only, and are not limiting. Further, user input during configuration could result in additional and/or different prompts to the user. For example, if the user indicates that the recorder is to be connected to the Internet, then a screen can instruct the user to connect the recorder to the router/modem for Internet access and provide a prompt for confirming the recorder is connected to the Internet. If the mobile device is also connected to the Internet, then at this point, the recorder and mobile device can communicate with each other over two connections simultaneously, namely the Internet and Bluetooth. This simultaneous connection can provide additional recorder configuration functionality. For example, when the user is prompted to pair the cameras, the camera identification can be sent from the recorder to the mobile device over the lower power Bluetooth connection, while simultaneously streaming live surveillance data from each of the cameras from the recorder to the mobile device over the faster Internet connection (so the user can confirm the image quality and field of view for each camera), as shown in FIGS. 7A and 7B.

Additional recorder set up features can be included using the Bluetooth connection between the recorder 14 and the mobile device 16. For example, still images of the surveillance data, or possibly the surveillance data itself, from the cameras can be sent to the mobile device over the Bluetooth connection to aid the user in confirming camera operation and determining desired camera mounting and alignment. Further, Bluetooth (which is a low power communications medium) can be used to send an event warning from the recorder 14 to the mobile device 16 (e.g., if the power or signal from one of the cameras is cut), if the recorder is tampered with, etc. The Bluetooth communication can also be used to carry credential information in a secure way to new devices (e.g., new cameras being added to the recorder).

The Bluetooth connection between the recorder and the mobile device provides a number of advantages as set forth above. Specifically, it allows the user to scan for devices without an account, finding nearby recorders and allowing the user to add discovered recorder devices using the Bluetooth connection. This ability can be premised on the recorder being proximate to the mobile device, and the recorder device is not already affiliated with an account. It allows the user to complete recorder set up using a mobile device connected to the recorder, including indicating if the cameras are connected correctly, using a Bluetooth connection, avoiding the need for other less convenience or unavailable equipment such as a monitor, keyboard and mouse. The Bluetooth functionality of the recorder and mobile device allows for the mobile device to pair with the recorder, and to unlock it when proximate to the recorder. The recorder and mobile device can be configured to additionally allow for an Internet connection between the mobile device and recorder, to exploit further set up and/or operational features of the recorder.

It is to be understood that the present disclosure is not limited to the example(s) described above and illustrated herein, but encompasses any and all variations falling within the scope of any claims. For example, references to the present disclosure or invention or examples herein are not intended to limit the scope of any claim or claim term, but instead merely make reference to one or more features that may be covered by one or more claims. While storage device 15 is shown as a single unit, it could be multiple separate storage units in recorder 14. For example, storage device 15 can include one unit for storing the surveillance data, and another unit for storing the recorder's settings. Hardware, software and/or firmware can be used to implement the configurations and operations of the recorder, and the mobile device, as described herein.

What is claimed is:

1. A method of configuring a recorder using a mobile device, comprising:
powering on a recorder, wherein the recorder is configured to receive and store surveillance data;
pairing the recorder to a mobile device via a Bluetooth connection; and
using the mobile device and the Bluetooth connection to configure one or more settings of the recorder.

2. The method of claim 1, wherein the pairing of the recorder to the mobile device via a Bluetooth connection comprises:
displaying a screen on the mobile device identifying the recorder; and
displaying a screen on the mobile device with a prompt for entering a name for the recorder.

3. The method of claim 1, wherein the using the mobile device and the Bluetooth connection to configure one or more settings of the recorder comprises:
displaying a screen on the mobile device with instructions to connect one or more cameras to the recorder;
connecting one or more cameras to the recorder; and
pairing the one or more cameras with the recorder.

4. The method of claim 3, wherein the connecting one or more cameras to the recorder comprises providing a wired connection or a wireless connection between each of the one or more cameras and the recorder.

5. The method of claim 3, further comprising:
storing surveillance data received from the one or more cameras paired with the recorder according to the configured one or more settings of the recorder.

6. The method of claim 3, wherein the using the mobile device and the Bluetooth connection to configure one or more settings of the recorder comprises:
displaying a screen on the mobile device identifying the one or more cameras paired with the recorder.

7. The method of claim 6, further comprising:
connecting the recorder to Internet; and
displaying a screen on the mobile device with a prompt for confirming the recorder is connected to the Internet;
wherein the displaying a screen on the mobile device identifying the one or more cameras paired with the recorder includes displaying on the mobile device surveillance data from the one or more cameras paired with the recorder.

8. The method of claim 1, wherein the using the mobile device and the Bluetooth connection to configure one or more settings of the recorder comprises:
displaying a screen on the mobile device with setting options for triggering storage of surveillance data by the recorder; and
using the mobile device and the Bluetooth connection to select one of the setting options for triggering storage of the surveillance data by the recorder.

9. The method of claim 8, wherein one of the setting options for triggering storage of the surveillance data by the recorder includes detection of motion.

10. The method of claim 8, wherein one of the setting options for triggering storage of the surveillance data by the recorder includes at least one of detection of a human, detection of a face, detection of a vehicle and detection of an animal.

11. A security camera system, comprising:
one or more cameras configured to generate surveillance data; and
a recorder that includes:
a processor and a storage device configured to receive and store the surveillance data; and
a Bluetooth transceiver configured to pair the recorder to a mobile device via a Bluetooth connection;
wherein the processor and the storage device are configured to set and store one or more settings of the recorder in response to information received over the Bluetooth connection.

12. The security camera system of claim 11, wherein the one or more settings comprises:
a name of the recorder.

13. The security camera system of claim 11, wherein the one or more settings comprises:
a setting for triggering storage of the surveillance data by the recorder in response to detection of motion.

14. The security camera system of claim 11, wherein the one or more settings comprises:
a setting for triggering storage of the surveillance data by the recorder in response to detection of at least one of a human, a face, a vehicle and an animal.

15. The security camera system of claim 11, wherein the one or more settings comprises:
identification of the one or more cameras configured to provide surveillance data to the recorder.

16. A security camera system, comprising:
a mobile device that includes a first Bluetooth transceiver;
one or more cameras configured to generate surveillance data; and
a recorder that includes:
a processor and a storage device configured to receive and store the surveillance data; and
a second Bluetooth transceiver configured to communicate with the first Bluetooth transceiver via a Bluetooth connection;
wherein the processor and the storage device are configured to set and store one or more settings of the recorder in response to information received from the mobile device over the Bluetooth connection.

17. The security camera system of claim 16, wherein the one or more settings comprises:
a name of the recorder.

18. The security camera system of claim 16, wherein the one or more settings comprises:
a setting for triggering storage of the surveillance data by the recorder in response to detection of motion.

19. The security camera system of claim 16, wherein the one or more settings comprises:
a setting for triggering storage of the surveillance data by the recorder in response to detection of at least one of a human, a face, a vehicle and an animal.

20. The security camera system of claim 16, wherein the one or more settings comprises:
identification of the one or more cameras configured to provide surveillance data to the recorder.
